(19) United States
(12) Patent Application Publication
(10) Pub. No.: US 2005/0080556 A1
(43) Pub. Date: Apr. 14, 2005

(54) Navigation system with routing

(75) Inventor: Winfried Toelle, (US)

Correspondence Address: CROWELL & MORING LLP;INTELLECTUAL PROPERTY GROUP, P.O. BOX 14300, WASHINGTON, DC, 20044-4300, US

(73) Assignee: PORSCHE AG

(21) Appl. No.: 10/922,155

(22) Filed: Aug. 20, 2004

(30) Foreign Application Priority Data
Aug. 21, 2003 (DE) 103 38 329.8

(51) Int. Cl. G01C 21/32; G08G 1/123

(52) U.S. Cl. 701/201; 701/208; 340/995.23; 701/211

(57) ABSTRACT

Map displaying device for a navigation system in a vehicle, the indication of the route from a starting point (SP) to a destination point (ZP) always being displayed independently of the actual position of the vehicle, and the covered route being visually differentiated from the route still to be driven.

### BACKGROUND AND SUMMARY OF THE INVENTION

This application claims the priority of German patent document 103 38 329.8, filed Aug. 21, 2003, the disclosure of which is expressly incorporated by reference herein.

The present invention relates to a navigation system having a map display for the route to be covered, particularly in the cross-country operation.

A map displaying device and a recording medium are known from German Patent Document DE 198 35 422 A1, having a vehicle navigation system with a routing which is then displayed.

By means of the map displaying device according to the invention, it becomes possible to more clearly display to the driver the routing from a Point A to a Point B, particularly off-the-road, to the driver, and to mark possible deviations from the course of the route.

Thus, it is advantageous that the route computed at the start together with its route course remains plotted during the entire drive and changes its color only after the route section has been travelled. Likewise, in the event of a deviation from the once defined course, for example, as a result of obstacles, the original route course in the map is maintained and the deviation is marked in the map, for example, by means of another color. Simultaneously, originating from this deviation, the optimal course is determined for the routing back to the originally computed course and is plotted in the map. When determining the optimal course for the routing back to the originally computed course, the own driving direction, the direction along the originally computed course and, for example, possible obstacles are taken into account. Thus, the optimal course for the routing-back is not necessarily the shortest course back. The possibility is conceivable here that several variants are offered for a selection by the vehicle driver.

It is therefore possible for the driver to orient himself in a very simple and rapid manner in his map displaying device and to read his actual momentary position.

Other objects, advantages and novel features of the present invention will become apparent from the following detailed description of the invention when considered in conjunction with the accompanying drawings.

### BRIEF DESCRIPTION OF THE DRAWINGS

FIG. 1 is a map with a course of a route with, the past course being marked to the starting point by means of a color which differs from the color of the course of the route which is ahead; and

FIG. 2 is a view of a route which is the result of a stringing-together of at least one individual destination and in the case of which the course of the route is plotted as a directed arrow.

### DETAILED DESCRIPTION OF THE DRAWINGS

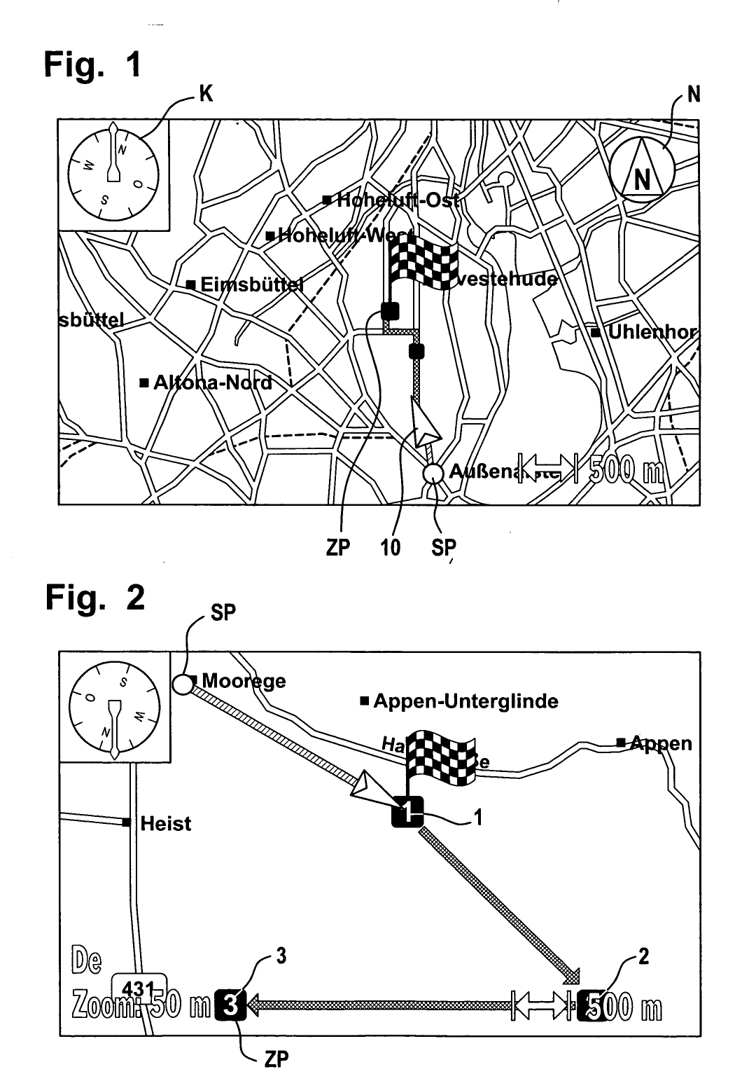

FIG. 1 illustrates a map which shows a compass in the left upper corner and a north arrow in the right upper corner, the compass being provided with the reference symbol K and the north arrow being provided with the reference symbol N. In this map of FIG. 1, the course of the route is indicated from a starting point SP to the destination point ZP which is marked by a destination flag in FIG. 1. The actual position is indicated in FIG. 1 by means of a triangle symbol, which has the reference number 10. The vertex of the triangle symbol 10 indicates his momentary moving direction to the driver. In addition, the map contains information concerning the actual size representation. The distance to be driven from the starting point SP to the destination point SZ and outlined in FIG. 1 is marked, and the distance already driven is illustrated differently than the distance still to be driven. In the present example the distance which is still to be driven is indicated in a hatched manner. A color change is also conceivable, in which case, the driven distance can be indicated, for example, in a gray tint, and the distance still to be driven can be indicated in a red tint.

FIG. 2 also illustrates a map with a plotted driving route from a starting point SP to a destination point ZP. Here, the same reference symbols are used as those selected for the same information in FIG. 1. In this representation, the distance still to be covered is divided into individual route sections, each route section being ended by an individual destination. For a better illustration, these individual destinations are numbered in the present map corresponding to their sequence (1, 2, 3).

This new map illustration according to the invention permits the guiding-along of a vehicle on a defined route by means of route points and a route recording or route definitions, while it is not required that an actual map is filed.

When guiding the vehicle back to the originally computed route after a deviation from the route, the driver can chose among different options. Thus, on the one hand, the shortest distance can be indicated for the routing-back, the route with the shortest driving time to the final destination can be indicated; or, for example, the route back to the deviation point can be indicated as possibilities.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A navigation system for a vehicle, comprising a map display device continuously displaying an a route from a starting point to a destination point independent of an actual position of the vehicle and displaying an already completed portion of the route in a visually different manner from a remaining portion of the route which is not yet completed.

2. Map displaying device according to claim 1, wherein the route between the starting point and the destination point is illustrated as a stringing-together of at least one individual destination, the course of the route being plotted as a directed arrow.

3. Map displaying device according to claim 1, wherein, in the event of a deviation of the actual position from the defined driving route, an originally computed driving route continues to be displayed in the navigation system, and the navigation system computes the optimal route from the actual location back to the originally computed driving route.

4. Map displaying device according to claim 1, wherein, the display of the driving route takes place without map data for navigation.

5. Map displaying device according to claim 2, wherein, the display of the driving route takes place without map data for navigation.

6. Map displaying device according to claim 3, wherein, the display of the driving route takes place without map data for navigation.

7. A method of displaying a map for a vehicle navigation system, comprising the steps:
displaying an actual position of said vehicle;
displaying an indication of a route from a starting point to a destination point continuously and independent of said actual position of said vehicle; and
displaying a first portion of the route already completed by said vehicle is a visually different manner then a remaining portion of said route.

8. The method according to claim 2, wherein the route between the starting point and the destination point is illustrated as a stringing-together of at least one individual destination, the course of the route being plotted as a directed arrow.

9. The method according to claim 7, wherein, in the event of a deviation of the actual position from the defined driving route, an originally computed driving route continues to be displayed in the navigation system, and the navigation system computes the optimal route from the actual location back to the originally computed driving route.

10. The method according to claim 7, wherein, the display of the driving route takes place without map data for navigation.

11. The method according to claim 8, wherein, the display of the driving route takes place without map data for navigation.

12. The method according to claim 9, wherein, the display of the driving route takes place without map data for navigation.
